(19) United States
(12) Patent Application Publication
(10) Pub. No.: US 2026/0222466 A1
(43) Pub. Date: Jul. 30, 2026

(54) METHOD AND SYSTEM TO ENABLE HIGH AVAILABILITY "THREE-SITE" APPLICATIONS USING ONLY TWO SITES

(71) Applicant: SAUDI ARABIAN OIL COMPANY, Dhahran (SA)

(72) Inventors: Mohammad Al-Jughaiman, Khobar (SA); Badi Al-Saleh, Safwa (SA); Badar Al-Qahtani, Dhahran (SA); Ali Al-Hussain, Safwa (SA)

(73) Assignee: SAUDI ARABIAN OIL COMPANY, Dhahran (SA)

(21) Appl. No.: 19/039,192

(22) Filed: Jan. 28, 2025

(51) Int. Cl. H04L 67/1001; G06F 9/455; G06F 11/14

(52) U.S. Cl. CPC H04L 67/1001; G06F 9/45558; G06F 11/1402; G06F 2009/45575

(57) ABSTRACT

System and method for providing a three-site configuration for a high-availability application with two computing sites. The method includes providing a first computing site with a first node initially designated as an active node and a second computing site physically displaced from the first computing site with a second node initially designated as a passive node. The method further includes providing a network storage that is mirrored between, and available to, the first computing site and the second computing site, and a witness node configured principally for voting which of the first and second nodes are the active and passive nodes, respectively, and hosted in the network storage. The witness node initially operates at the first computing site and the first computing site and the second computing site are configured as a stretched cluster.

### BACKGROUND

Some applications or software programs or systems require high availability. For example, a centralized management platform used to monitor and control virtual machines or distribute and manage computational tasks among hardware resources can be considered an application that requires high availability. Often, high availability is achieved using three nodes forming, or of, a cluster of nodes and referred to as a first node, second node, and witness node. The first and second nodes are designated as either an active node or a passive node, where this designation is mutually exclusive (e.g., the first node and second node cannot simultaneously be active). The witness node is used to determine a status of the first and second nodes and provide a vote (or establish a quorum) as to whether a designation of the first and second nodes as either active or passive should be switched, remain the same, or otherwise altered. Under this configuration, the three nodes work together to provide high availability, principally through redundancy, forming an active-passive failover solution.

In some scenarios, the high availability of an application provided by the above-described three-node configuration is enhanced by distributing these nodes to three different physical sites (“computing sites”). By placing the nodes at different computing sites distinguished at least by a geographical separation, the risk of application loss, failure, or outage is mitigated against issues at any one computing site such as an electrical fire, flooding, and/or occurrence of a natural disaster (e.g., structural damage from an earthquake). Further, in some instances, application and/or high performance computing vendors will only certify the high availability solution if the three nodes exist at three different computing sites.

Computing sites are associated with a high capital expenditure as a computing site often requires a specialized building (e.g., configured to provide power, cooling, and network capabilities), equipment (e.g., computing resources such as servers, network switching, cooling units, etc.), and manpower to construct, maintain, and operate the computing site. As such, it may not be economically feasible, efficient, or strategic for an organization or enterprise that owns or operates the cluster to provide three physically-separated computing sites. Accordingly, there exists a need to enable high-availability applications that conventionally require three computing sites to run using only two computing sites while retaining their high availability.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein generally relate to a system for providing a three-site configuration for a high-availability application with two computing sites. The system includes a first computing site with a first node initially designated as an active node and a second computing site physically, displaced from the first computing site, and with a second node initially designated as a passive node. The system further includes a network storage that is mirrored between, and available to, the first computing site and the second computing site. The system further includes a witness node configured principally for voting which of the first and second nodes are the active and passive nodes, respectively, and hosted in the network storage. In the system, the witness node initially operates at the first computing site, and the first computing site and the second computing site are configured as a stretched cluster.

In one aspect, embodiments disclosed herein relate to a method for providing a three-site configuration for a high-availability application with two computing sites. The method includes providing a cluster including a plurality of nodes distributed over a first computing site and a second computing site configured as a two-site stretched cluster, where the cluster has network resources including network storage and is configured with a virtualized environment. The method further includes monitoring compute and memory resources of the plurality of nodes and determining, from the plurality of nodes, a witness node that uses less compute and memory resources relative to the other nodes in the plurality of nodes. The method further includes creating a mirrored storage between the first and second computing sites and moving the witness node into the mirrored storage. The method further includes determining, based on the witness node, an active node and a passive node in the plurality of nodes, where no pair of the active, passive, and witness nodes are the same node. The active node is, at least initially, at the first computing site and the passive node is at the second computing site. The method further includes running a high-availability application on the active node and replicating the active node to the passive node.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts an example cluster in accordance with one or more embodiments.

FIG. 2A depicts an example node in accordance with one or more embodiments.

FIG. 2B depicts example nodes in accordance with one or more embodiments.

FIG. 3 depicts a cluster configured for a conventional three-site high availability application, in accordance with one or more embodiments.

FIG. 4 depicts a failure of a site of a three-site cluster, in accordance with one or more embodiments.

FIG. 5 depicts a two-site cluster configured to run three-site high-availability applications, in accordance with one or more embodiments.

FIG. 6 depicts operation of a two-site cluster configured to run three-site high-availability applications, in accordance with one or more embodiments.

FIG. 7 depicts a block diagram of a system for operating a three-stie high-availability application with a cluster with nodes distributed over two computing sites, in accordance with one or more embodiments.

FIG. 8 depicts a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “processor” may include any number of “processors” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

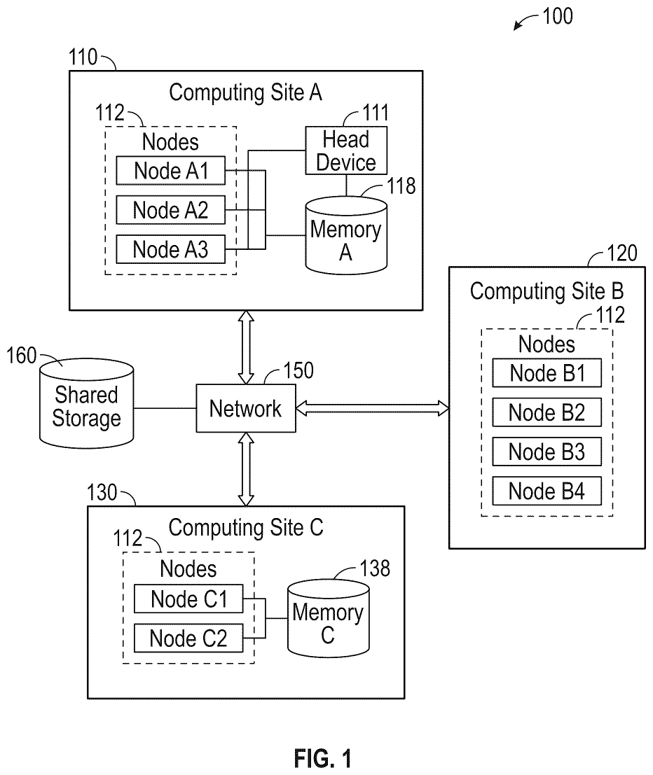

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments disclosed herein relate to a system and method to enable high-availability applications that conventionally require three computing sites to run using only two computing sites while retaining their high availability. A collection of computing devices (e.g., computers, servers, etc.) that collaborate to perform one or more computing tasks are known as a cluster. In general, each computing device in the cluster is called a node. A cluster can include various other devices for transferring data between nodes (e.g., wireless communication devices and protocols, cables, network switch(es)), organizing and distributing computing tasks among the nodes (e.g., load balancers), and storing and sharing data (e.g., memory devices such as hard drives). Nodes of a cluster can be distributed among one or more computing sites distinguished by a physical separation. For example, a first set of nodes of a cluster can be located at a first computing site at a first location and a second set of nodes of the cluster can be located at a second computing site located at a second location. Distribution of nodes of a cluster to two or more computing sites with physical separation can be used to provide redundancy and continued availability to the cluster because issues local to a computing site (e.g., power outage, structural damage, etc.) do not affect the other computing sites.

FIG. 1 depicts an example cluster (100). In FIG. 1, the example cluster (100) is depicted as having nine nodes (112) (nodes A1-A3, B1-B4, and C1-C2) distributed over three computing sites (computing site A (110), computing site B (120), and computing site C (130)). The computing sites (110, 120, 130) are said to be located at different geographical locations. The computing sites (110, 120, 130) are connected by a network (150) for passing messages and data. In the example of FIG. 1, the cluster (100) further includes shared storage (160) where data common to, or needed by, all of the nodes is stored. The computing sites need not be arranged identically or contain the same components. As seen in FIG. 1, computing site A (110) contains three nodes (112) (node A1, node A2, and node A3) connected to a head device (111) and local memory (memory A (118)). The head device (111) may itself be a node. The head device (111) may be responsible, for example, for coordinating computational tasks local to the computing site A (110). In the depicted example, computing site B (120) differs from computing site A (110) in that it only contains nodes, specifically, four nodes (112) (node B1, node B2, node B3, and node B4). Computing site C (130) also differs from computing sites A and B (110, 120) and includes two nodes (112) (node C1, node C2) and local memory (memory C (138)).

It is emphasized that the cluster (100) depicted in FIG. 1 is given solely as an example and should not be considered limiting. Clusters can be configured in a variety of ways, for example: with and without shared storage; having a different number and distribution of nodes; including additional devices such as network switches and load balancers; etc. The configuration of a cluster can be defined according to a cluster architecture, where the architecture may further be specified according to a software architecture and a system (e.g., hardware) architecture. For example, software architectures can include layered architecture, object-based architecture, event-based architecture, and data-centered architecture. System architectures can include peer-to-peer architecture and client-server architecture, among others. In general, embodiments disclosed herein are not limited to any specific cluster configuration or architecture.

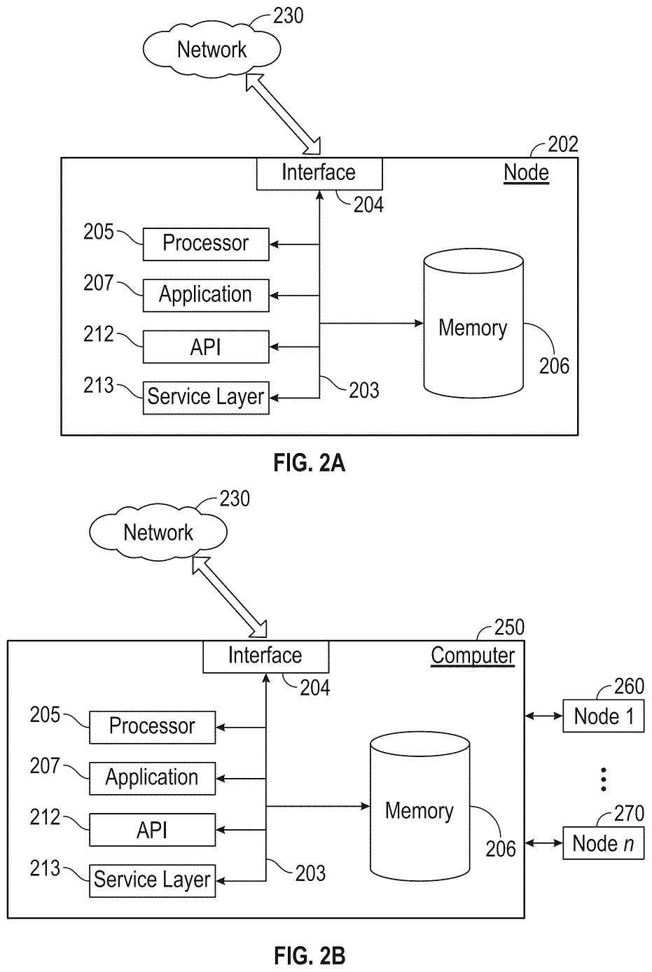

FIG. 2 depicts a block diagram of a node (202) used to provide computational functionalities associated with described algorithms, methods, functions, processes, flows, and procedures as described in this disclosure, according to one or more embodiments. The illustrated node (202) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the node (202) may include a computer that includes an input device, such as a keypad, keyboard, touch screen, or other device that can accept user information, and an output device that conveys information associated with the operation of the node (202), including digital data, visual, or audio information (or a combination of information), or a GUI.

The node (202) can serve in a role as a client, network component, a server, a database or other persistency, or any other component (or a combination of roles) of a computer system for performing the subject matter described in the instant disclosure. In some implementations, one or more components of the node (202) may be configured to operate within environments, including cloud-computing-based, local, global, or other environment (or a combination of environments).

At a high level, the node (202) is an electronic computing device operable to receive, transmit, process, store, or manage data and information associated with the described subject matter. According to some implementations, the node (202) may also include or be communicably coupled with an application server, e-mail server, web server, caching server, streaming data server, business intelligence (BI) server, or other nodes (or a combination of nodes) (e.g., to form a cluster).

The node (202) can receive requests over network (230) from a client application (for example, executing on another node (202) and responding to the received requests by processing the said requests in an appropriate software application. In addition, requests may also be sent to the node (202) from internal users (for example, from a command console or by other appropriate access method), external or third-parties, other automated applications, as well as any other appropriate entities, individuals, systems, or computers.

Each of the components of the node (202) can communicate using a system bus (203). In some implementations, any or all of the components of the node (202), both hardware or software (or a combination of hardware and software), may interface with each other or the interface (204) (or a combination of both) over the system bus (203) using an application programming interface (API) (212) or a service layer (213) (or a combination of the API (212) and service layer (213). The API (212) may include specifications for routines, data structures, and object classes. The API (212) may be either computer-language independent or dependent and refer to a complete interface, a single function, or even a set of APIs. The service layer (213) provides software services to the node (202) or other components (whether or not illustrated) that are communicably coupled to the node (202). The functionality of the node (202) may be accessible for all service consumers using this service layer. Software services, such as those provided by the service layer (213), provide reusable, defined business functionalities through a defined interface. For example, the interface may be software written in JAVA, C++, or other suitable language providing data in extensible markup language (XML) format or another suitable format. While illustrated as an integrated component of the node (202), alternative implementations may illustrate the API (212) or the service layer (213) as stand-alone components in relation to other components of the node (202) or other components (whether or not illustrated) that are communicably coupled to the node (202). Moreover, any or all parts of the API (212) or the service layer (213) may be implemented as child or sub-modules of another software module, enterprise application, or hardware module without departing from the scope of this disclosure.

The node (202) includes an interface (204). Although illustrated as a single interface (204) in FIG. 2, two or more interfaces (204) may be used according to particular needs, desires, or particular implementations of the node (202). The interface (204) is used by the node (202) for communicating with other systems in a distributed environment that are connected to the network (230). Generally, the interface (204) includes logic encoded in software or hardware (or a combination of software and hardware) and operable to communicate with the network (230). More specifically, the interface (204) may include software supporting one or more communication protocols associated with communications such that the network (230) or interface's hardware is operable to communicate physical signals within and outside of the illustrated node (202).

The node (202) includes at least one computer processor (205). Although illustrated as a single computer processor (205) in FIG. 2, two or more processors may be used according to particular needs, desires, or particular implementations of the node (202). Generally, the computer processor (205) executes instructions and manipulates data to perform the operations of the node (202) and any algorithms, methods, functions, processes, flows, and procedures as described in the instant disclosure.

The node (202) also includes a memory (206) that holds data for the node (202) or other components (or a combination of both) that can be connected to the network (230). The memory may be a non-transitory computer readable medium. For example, memory (206) can be a database storing data consistent with this disclosure. Although illustrated as a single memory (206) in FIG. 2, two or more memories may be used according to particular needs, desires, or particular implementations of the node (202) and the described functionality. While memory (206) is illustrated as an integral component of the node (202), in alternative implementations, memory (206) can be external to the node (202).

The application (207) is an algorithmic software engine providing functionality according to particular needs, desires, or particular implementations of the node (202), particularly with respect to functionality described in this disclosure. For example, application (207) can serve as one or more components, modules, applications, etc. Further, although illustrated as a single application (207), the application (207) may be implemented as multiple applications (207) on the node (202). In addition, although illustrated as integral to the node (202), in alternative implementations, the application (207) can be external to the node (202).

There may be any number of nodes (202) associated with, or external to, a computer system or cluster containing node (202), wherein each node (202) communicates over network (230). Further, the term “client,” “user,” and other appropriate terminology may be used interchangeably as appropriate without departing from the scope of this disclosure. Moreover, this disclosure contemplates that many users may use one node (202), or that one user may use multiple nodes (202).

As stated, a node can include both physical or virtual instances (or both) of a computing device. FIG. 2 generally depicts the node as being consistent with a dedicated group of hardware (e.g., processor (205), memory (206), interface (204)) and software or other abstracted layers (e.g., service layer (213), API (212)). However, in some instances, one or more nodes can be operated using a single grouping of hardware and/or software, e.g., as a virtual instance (or virtual machine). FIG. 2B depicts a group of hardware and software forming a computer (250). The description of the computer (250) is the same as that for the node (202) of FIG. 2 and is not repeated here for concision. FIG. 2B differs from FIG. 2 in that the computer (250) operates n nodes, where n≥1. FIG. 2B depicts node 1 (260) through node n (270) operating using the same computer, e.g., as virtual machines (or virtual instances or containers). In general, a virtual machine is a virtual representation or emulation of a physical computer that uses software instead of hardware to run programs and deploy applications. Thus, the compute and memory resources of a computer (250) can be partitioned for use by one or more nodes (260, 270). In accordance with one or more embodiments, a node can be a virtual machine using a portion of the compute and memory resources of a “hardware node” (e.g., a computer (250)) on which the virtual machine is instantiated and operated. Hereafter, no distinction between nodes of the type of FIG. 2A and FIG. 2B are made. One with ordinary skill in the art will readily appreciate that embodiments disclosed herein are readily understood using the above-description of nodes.

Benefits of using a cluster (100) composed of nodes (112, 202) include improved scalability, increased performance through parallelization of computing tasks, and improved reliability due to redundancy, among others. Some applications or software programs or systems require high availability. For example, a centralized management platform used to monitor and control virtual machines or distribute and manage computational tasks among hardware resources can be considered an application that requires high availability. Other examples of systems that often require high availability include health care records and networks and processing system related to autonomous vehicles.

The term high availability indicates that a system (e.g., executed using a cluster) is accessible and operational near 100% of the time (e.g., the so-called “five nines” availability indicates that the system is operational 99.999% of the time). High availability is often associated with disaster recovery and fault tolerance. Typically, disaster recovery relates to the technology infrastructure (e.g., cluster system architecture) and predefined practices that are implemented in response to a disruption due to a catastrophic event. Sometimes, the terms high availability and disaster recovery are distinguished according to a severity of a disruption, however, no such distinction is made herein. Similarly, fault tolerance often refers to a system's ability to function when one or more of its critical components fail and is focused on providing a system with zero downtime. Again, herein, no distinction between high availability and fault tolerance is made.

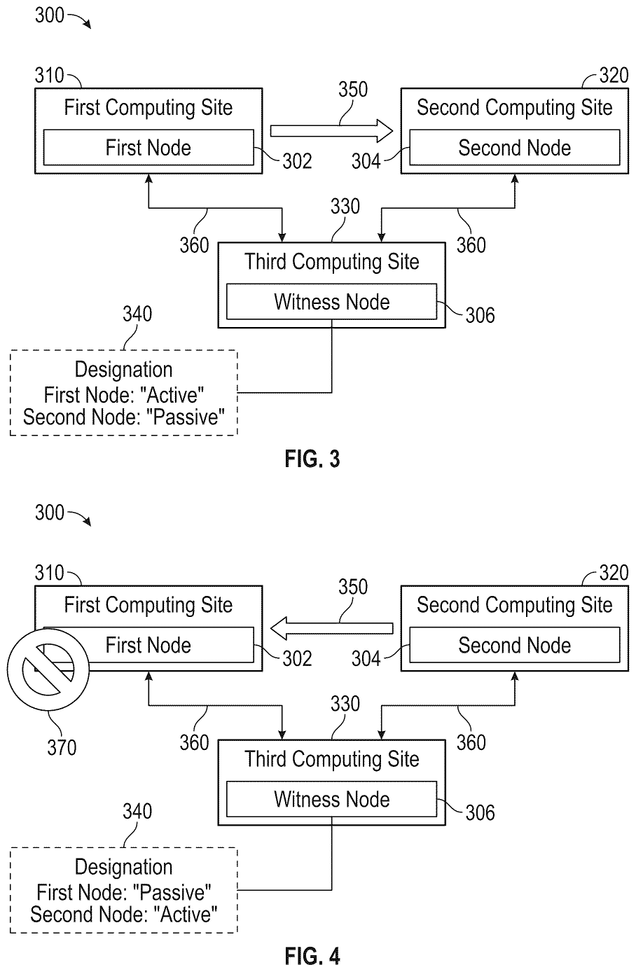

Turning to FIG. 3, often, high availability is achieved using three nodes forming, or of, a cluster (300) of nodes and referred to as a first node (302), second node (304), and witness node (306). While FIG. 3 depicts only three nodes, in general, additional nodes can be included. For example, the first computing site (310) can include a third node (not depicted), a fourth node (not depicted), etc. As another example, the first node (302) and the second node (304) can each be composed of five nodes, ten nodes, or any number of nodes (e.g., virtual machine instances of nodes). Further, the number of nodes included by any labelled node in FIG. 3 (e.g., first node and second node) need not be the same between labelled nodes.

The first and second nodes (302, 304) are designated (see designation (340)) as either an “active” node or a “passive” node, where this designation is mutually exclusive (e.g., the first node (302) and second node (304) cannot simultaneously be active). The witness node is used to determine a status of the first and second nodes (302, 304) and provide a vote (or establish a quorum) as to whether a designation of the first and second nodes (302, 304) as either active or passive should be switched, remain the same, or otherwise altered. For example, if the first and second nodes (302, 304) lose communication with each other witness node (306) arbitrates the designation (340) of the first and second nodes (302, 304). Under this configuration, the three nodes work together to provide high availability, principally through redundancy, forming an active-passive failover solution. In the example of FIG. 3, the current designation (340), as attested to by the witness node (306), is that the first node (302) is active and the second node (304) is passive.

In some scenarios, the high availability of an application provided by the above-described three-node configuration is enhanced by distributing these nodes to three different physical sites (“computing sites”). By placing the nodes at different computing sites distinguished at least by a geographical separation, the risk of application loss, failure, or outage is mitigated against issues at any one computing site such as an electrical fire, flooding, and/or occurrence of a natural disaster (e.g., structural damage from an earthquake). Further, in some instances, application and/or high performance computing vendors will only certify the high availability solution if the three nodes exist at three different computing sites. FIG. 3 further depicts such a three-site configuration where the first node (302) is at a first computing site (310), the second node (304) is at a second computing site (320), and the witness node (306) is at a third computing site (330); and the computing sites (310, 320, 330) are said to be located at different geographical locations.

As depicted in FIG. 3, initially, the first node (302) is designated (340) as the active node and is cloned to the second node (304) designated as the passive node. In some instances, the first or active node is also cloned to the witness node, where witness node may have a “lightweight” clone. Further, when the cluster (300) is functioning, the active node replicates data to the passive node. The directed arrow (350) of FIG. 3 depicts the data replication of the first node (302) to the second node (304). The witness node (306) is used to arbitrate, or vote, on the status of the cluster (i.e., the status of at least the first and second nodes (302, 304)) in the event of a failure of the first node (302) or second node (304), themselves, and/or communication issues (i.e., network issues) between these nodes. In the event of a failure of a node or other issue (e.g., communication issue) the witness node determines which of the first and second nodes (302, 304) should be considered the active node, and consequently designating the remaining node as the passive node. The bidirectional arrows (360) of FIG. 3 indicate the monitoring of the first and second nodes (302, 304) by the witness node (306) and interaction between these node, e.g., to alter the designation (340). For example, a failure of the first node (302) initially designated as the active node will result in the passive node (i.e., the second node (304)) becoming the active node until a restoration of the first node (302) is completed. Upon restoring the first node (302), the first node (302) can revert to the active node or remain as the passive node providing redundancy for the now-designated as active second node (304), as desired or configured by a system administrator.

FIG. 4 depicts a scenario in which the first node (302), designated as the active node, has experienced a failure (370). In this scenario, the witness node (306) detects the failure (e.g., detection (360)) and alters the designation (340) of the first and second nodes (302, 304). In particular, the second node (304) is designated as the active node and the first node (302) is designated as the passive node. Once the first node (302) is restored, data replication (350) occurs from the second node (304) to the first node (302).

In some instances, application and/or high performance computing vendors will only certify the high availability solution if the three nodes exist at three different computing sites, as depicted in FIGS. 3 and 4 (i.e., first, second, and third computing sites (310, 320, 330)). However, individual computing sites are associated with a high capital expenditure as each computing site often requires a specialized building (e.g., configured to provide power, cooling, and network capabilities), equipment (e.g., computing resources such as servers, network switching, cooling units, etc.), and manpower to construct, maintain, and operate the computing site. As such, it may not be economically feasible, efficient, or strategic for an organization or enterprise that owns or operates the cluster (300) to provide three physically-separated computing sites (e.g., first, second, and third computing sites (310, 320, 330)). Embodiments disclosed herein relate to a system and method to enable high-availability applications that conventionally require three computing sites to run using only two computing sites while retaining their high availability.

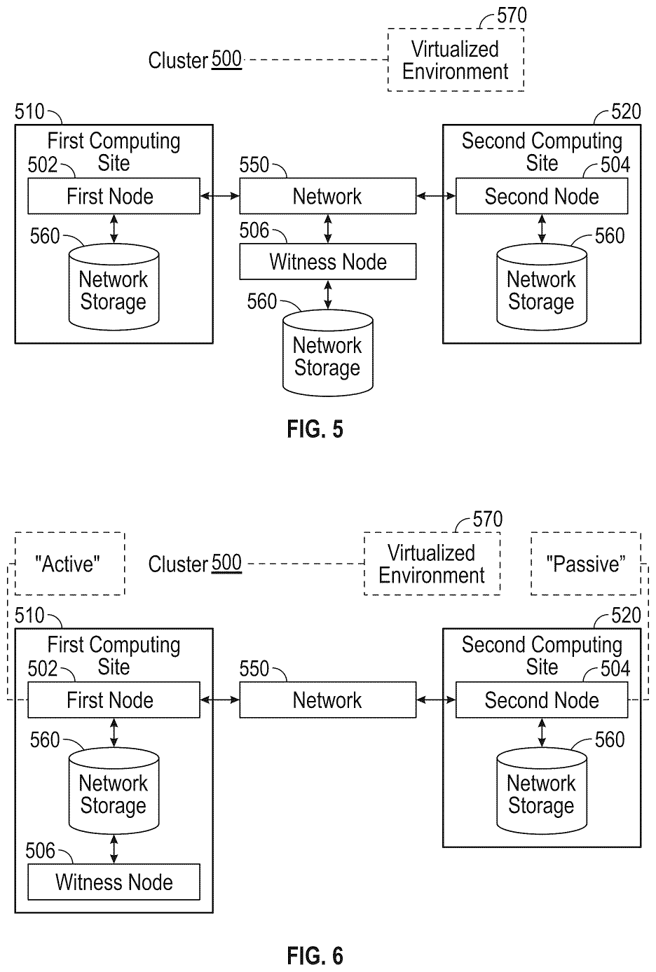

In accordance with one or more embodiments, two geographically separate computing sites are provided and configured to run so-called three-site applications. FIG. 5 depicts a cluster (500) in accordance with one or more embodiments. As seen, the cluster (500) is composed of, at least, three nodes: a first node (502), a second node (504), and a witness node (506). The first node (502) is located at a first computing site (510) and the second node is located at a second computing site (520). The first and second computing sites (510, 520) are at different geographical locations. The cluster (500) is said to be a stretched cluster between the two computing sites (first and second computing sites (510, 520)) with network resources (550) and network storage (560). The network-based storage solution (using network (550) and network storage (560)) is capable of mirroring or replicating data across the first and second computational sites (510, 520). Further, the cluster (500) is said to be configured as, or for use with or management of, a virtualized environment (570) with the ability to restart virtual machines (or containers) in the event of failures of one or more nodes of the cluster (500). In summary, embodiments disclosed herein require: 1) a virtualized environment with the ability to restart virtual machines (or containers) in response to failure events; 2) a network-based storage solution that can be mirrored across the first and second computing sites (510, 520) and withstand the failure of a computing site; and the availability of a stretched cluster between the first and second computing sites (510, 520) including network resources (550).

In accordance with one or more embodiments, the cluster (500) includes a witness node (506). The witness node (506) does not require the same computational resources as the first and second nodes (502, 504) and is used solely for voting (i.e., establishing a quorum, designation of nodes as active or passive). In accordance with one or more embodiments, and in strict departure from conventional three-site systems, the witness node (506), once identified, is placed in the shared network storage (560).

The identification of the witness node (506) is performed as follows. In some scenarios, the witness node (506) is initially provided on a given node (or portion of a node using a virtual machine). For example, the witness node (506) can initially be specified as a node residing at the first computing site (510). In other scenarios, the witness node (506) is not identified by default and is instead identified by a comparison of compute and memory resources. In these scenarios, following the above-listed requirement that the witness node (506) be used solely for voting (or otherwise have a small computational requirement), the witness node (506) is identified by monitoring the compute and memory resources of the cluster (500). Specifically, the compute and memory resources of the nodes of the cluster using a virtualized environment (i.e., a “hardware node” or computer can operate a more than one node using virtual machines) are monitored. The witness node (506) is identified as the node (or virtual machine or container) that uses less compute and memory resources than other nodes (or virtual machines or containers). In some embodiments, the storage utilization between nodes is also monitored and considered, where the node that uses less storage utilization relative to other nodes (and in view of the compute and memory resource usage) is identified as the witness node. Once the witness node (506) is identified, the witness node (506) is placed in the mirrored network storage (560) between the first and second computing sites (510, 520). In some implementations, the mirrored storage uses a network file system (NFS) or common internet file system (CIFS) file access storage protocol. The mirrored storage (e.g., network storage (560)) is created between the first and second computational sites (510, 520), where the witness node (506)—once identified—is placed within this created mirrored storage.

FIG. 6 depicts an example, where the witness node (506) has been identified to reside in, or be within a node in, the first computing site (510). The first computing site (510) operates the witness node (506) and associated first node (502); as such, the first node (502) is designated as active. FIG. 6 depicts the first node (502) at the first computing site (510) as “active.” Thus, the associated nodes of the second computing site (e.g., second node (504)) are designated as passive (520). FIG. 6 depicts the second node (504) at the second computing site (520) as “passive.” In accordance with one or more embodiments, the resource usage of the nodes in the cluster (500) and general performance of the application(s) run using the cluster (500) are monitored. The cluster (500) provides a failover solution as follows. In general, a failure can occur at either the first computing site (510) or the second computing site (520) such that the failover solution disclosed herein accounts for two failure scenarios. The following two failure scenarios are described in accordance with the example of FIG. 6, where the first node (502) is active because the witness node (506) operates at the same computing site as the first node (502); namely, the first computing site (510). In a first scenario, a failure occurs at the second computing site (520). In this scenario, operation and function of the application continues normally because the first node (502) and witness node (506) in the first computing site (510) are both accessible and functional. In a second scenario, a failure occurs at the first computing site (510). In this scenario, operation and function of the application is temporarily suspended or stunned as the witness node (506) is restarted from the network storage (560) is run within or on a node at the second computing site (520). Once the witness node (506) is restarted at the second computing site (520), the associated second node (504) is designated as the active node (not depicted). The first computing site (510), or more specifically the first node (502), once reactivated serves as the passive site and/or node.

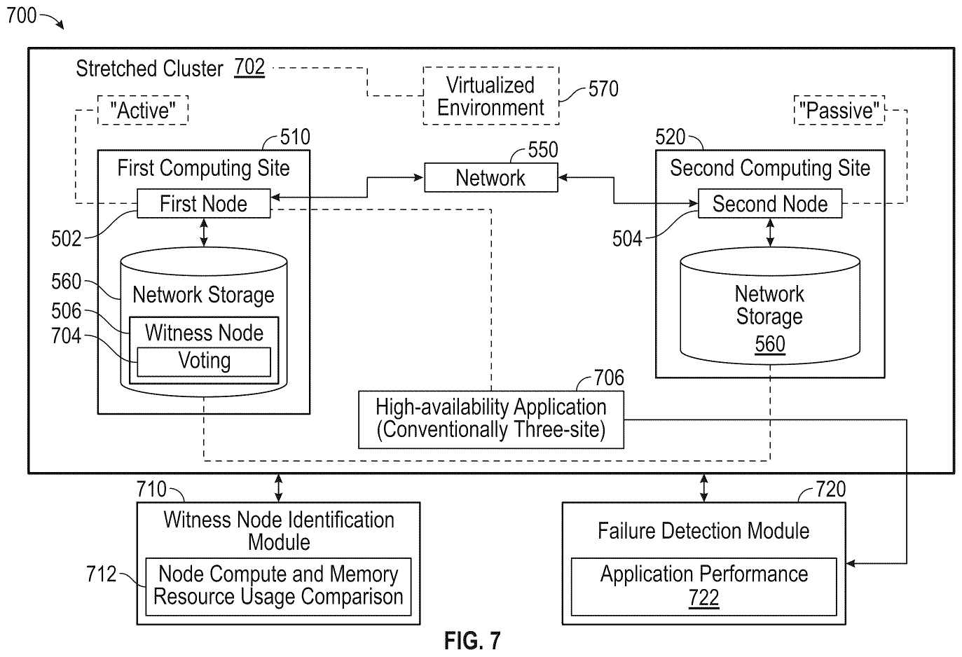

FIG. 7 depicts a system (700) for providing a three-site configuration (i.e., conventionally using three computing sites) for a high-availability application with two computing sites. As seen in FIG. 7, the system (700) includes a stretched cluster (702) with a plurality of nodes distributed over a first computing site (510) and a second computing site (520). In one or more embodiments, the first and second computing sites, or their respective nodes, are connected by a wide area network (WAN) (e.g., network (550)) forming the stretched cluster (702). As previously described, the stretched cluster is configured as, or with, a virtualized environment (570) capable of managing one or more virtual machines (or virtual instances or containers). The first computing site (510) includes a first node (502) initially designated as an active node. The second computing site (520) is physically displaced from the first computing site (510) (i.e., the first and second computing sites (510, 520) are at different geographical locations and connected by the WAN) and includes a second node (504) initially designated as a passive node. The stretched cluster (702) includes a network storage (560) that is mirrored between, and available to, the first computing site (510) and the second computing site (520). A witness node (506) that is configured principally for voting (704) which of the first and second nodes (502, 504) are the active and passive nodes, respectively, is hosted in the network storage (560). Further, the witness node (506) initially operates at the first computing site (510). FIG. 7 differs slightly from FIGS. 5 and 6 in that the witness node (506) is depicted as being within, or hosted in, the network storage (560) and implemented the first computing site (510). However, one with ordinary skill in the art will recognize that this depiction is to illustrate the points that, in accordance with embodiments disclosed herein, the witness node (506) is hosted in the network storage (560) and implemented, at least initially, at the first computing site (510). That said, the various viewpoints of the cluster (500) or stretched cluster (702) provided by FIGS. 5-7 are compatible.

Continuing with FIG. 7, the system (700) includes, or is used to run, a high-availability application (706). In one or more embodiments, the high-availability application (706) is an application that is conventionally run using a three-site system, or a cluster with an active node, passive node, and witness node located at three different geographical locations (i.e., three computing sites).

Keeping with FIG. 7, the system (700) further includes a failure detection module (720) configured to detect a failure of the first node and designate the second node as the active node and the first node as the passive node in response to the detected failure. In accordance with one or more embodiments, the failure detection module (720) determines an application performance (722) of the high-availability application (706). In instances where the application performance (722) demonstrates degradation, e.g., compared to previously determined application performances with respect to time or a noted deactivation or loss of the high-availability application (706), the failure detection module (720) determines that a failure has occurred at the first computing site (510). In response to the detected failure of the first computing site (510), or more specifically, the first node (502), the witness node (506) is restarted from the network storage (560) at the second computing site (520). Further, in response to (or in coordination with) the restart of the witness node (506) at the second computing site (520), the second node (504) is designated as the active node and the first node (502) as the passive node. In accordance with one or more embodiments, the witness node (506) is configured to vote (704) as the active node the first node (502) or the second node (504) according to the computing site in which the witness node (506) operates. For example, if the witness node (506) is implanted at the second computing site (520), then the second node (504) being a node that resides at the second computing site (520) is voted (704) or otherwise designated as the active node while the first node (502) being a node that resides at the first computing site (520) where the first computing site (510) is not implementing the witness node (506) is designated as the passive node. The reverse scenario occurs when the witness node (506) is implemented at the first computing site (510). Thus, under one viewpoint, the system (700) effectively simulates a third computing site by the hosting the witness node (506) in the network storage (560) that is available to the first computing site (510) and the second computing site (520). The system (700) is further configured to restart a virtual machine of the one or more virtual machines in response to a detected failure. For example, the witness node (506) can be restarted in response to a detected (i.e., determined) failure. Thus, the system (700) provides high availability because the network storage (560) is unaffected by a non-concurrent failure of the first and second computing sites (510, 520).

In one or more embodiments, the failure detection module (720) is provided by software associated with, or provided by, or used to manage, the cluster. That is, the failure itself can be handled by clustering software and embodiments disclosed herein give greater focus to methods and systems that ensure the witness node (506) is available to allow the cluster to failover the high-availability application.

Keeping with FIG. 7, the system (700) further includes a witness node identification module (710) that identifies the witness node (506) within the plurality of nodes included in in the stretched cluster (702). In one or more embodiments, the witness node identification module (710) is configured to determine the witness node (506) within the plurality of nodes based on a comparison of the compute and memory usage of the plurality of nodes, i.e., through a node compute and memory resource usage comparison (712)). In some embodiments, the node compute and memory resource usage comparison (712) further includes a comparison of the relative storage utilization of nodes. In general, the witness node identification module (710) identifies the witness node (506) as the node that uses less of one or more of compute resources, memory resources, and storage utilization relative to other nodes. In one or more embodiments, compute resources refer to the usage of a processor (205) used by the node (or virtual machine), memory resources refer to the usage of a local memory (206) such as the memory of a computer (250) on which the node is implemented as a virtual instance, and storage utilization refers to the usage of the shared network storage (560) by the node. In one or more embodiments, vendor-documents for the application are referenced to determine an expected node usage by the application. Then, the witness node (506) is identified as a node having a usage (e.g., compute, storage, etc.) less than the expected usage of a node running the application. In some cases, the witness node (506) must have a usage below a predefined threshold where the threshold is based on the expected usage of a node by the application (e.g., threshold is 50% the expected application usage). In other embodiments, monitoring of storage usage is sufficient to identify the witness node (506) as, according to a requirement of the instant disclosure that the witness node (506) be used primarily for voting, the witness node (506) is not expected to read or write to the storage.

In summary, embodiments disclosed herein relate to a system and method that allows for three-site high-availability applications to operate using only two computing sites, while still ensuring that the high-availability application remains reliable and continuously available. Typically, high availability setups require three computing sites where a first computing site includes an active node that handles the main tasks of the application, a second computing site includes a passive node that takes over if the active node fails, and a third computing site includes a witness node that decides which node of the first and second computing sites should be designated as active in case of any issues at either of the first and second computing sites. In accordance with embodiments disclosed herein, only two computing sites are necessary because the witness node is placed in shared storage, accessible to both the first and second computing sites. Further, if one of the first and second computing sites fails, the application can seamlessly transition to the other, still-operational site, though there may be a brief delay as the witness node is restarted on the operational site. It is noted that embodiments disclosed herein are ideal for setups where the witness node is used solely for voting (e.g., establishing a quorum) rather than performing intensive tasks. Further, embodiments disclosed herein rely on virtual machines for easier recovery and restarts and utilize mirrored storage to ensure that data is consistently available at both the first and second computing sites. Benefits of embodiments disclosed herein include a reduction of cost and resource requirements by eliminating the need for a third computing site, while still maintaining high availability of an application in the event of a failure.

In the event of a detected failure, e.g., using a failure detection module and/or software of the cluster itself, it may be said that one computing site is not operational. A node of the nonoperational computing site will not be available and a cluster will detect the failure and join its vote with the witness node to bring the application online on a healthy node (i.e., the node at the operational computing site). Without the witness node the vote count is not enough and the cluster cannot bring the application back online until it secures at least two votes. Embodiments disclosed herein provide methods and systems that ensure the witness node is always available for voting using only two sites instead of three with a minor drawback of small delay in the application recovery time if the failure site contained the witness node until the node is started on the other site. Thus, embodiments disclosed herein eliminate the costs and need of a third site, where this third site may not be feasible for an organization.

While the preceding examples discuss a first node (502) at a first computing site (510) and a second node (504) at a second computing site (520), where designation of either the first or second node (502, 504) is performed using a witness node (506), one with ordinary skill in the art will recognize that embodiments disclosed herein are readily applicable to computing sites with more nodes and the cluster (500) can operate more than one high-availability application. For example, the first computing site can have a first node designated as active by a first witness node also at the first computing site, where the first node provides a first application and is replicated to a second node at the second computing site. Additionally, the second computing site can have a third node designated as active by a second witness node also at the second computing site, where the third node provides a second application and is replicated to a fourth node at the first computing site. In this example, the first, second, third, and fourth nodes are all part of the cluster and distributed across the first and second computing sites. Further, in this example, the first and second applications are active at different computing sites.

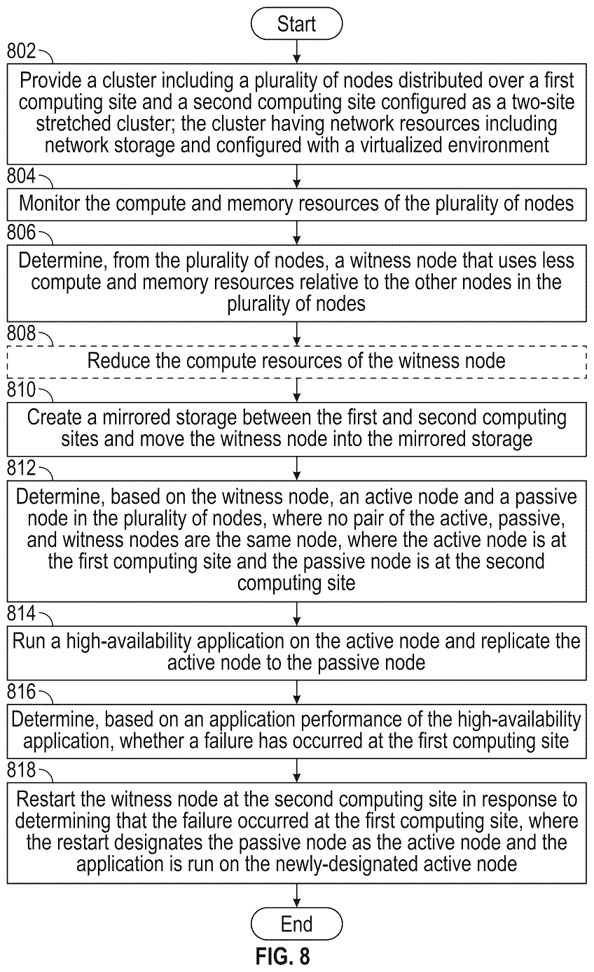

FIG. 8 depicts a flowchart describing the establishment and method of use of a two-computing-site (“two-site”) cluster configured to run high-availability three-site applications using only the two sites of the cluster. In Block 802 a cluster is provided. The cluster includes a plurality of nodes distributed over a first computing site and a second computing site configured as a two-site stretched cluster. Additionally, the cluster has network resources including network storage and is configured with a virtualized environment (i.e., virtual machines can be instantiated and managed such that a node can be a virtual instance and more than one node can be executed using a single computer (250)). In Block 804, the compute and memory resources of the plurality of nodes are monitored. For example, the usage of a processor (205) and computer memory (206) of a node of a computer (250) are determined as compute resource usage and memory resource usage, respectively. In Block 806, the compute and memory resource usage of the nodes of the plurality of nodes are compared (i.e., relative to each other) to determine, from the plurality of nodes, a witness node that uses less relatively less compute and memory resources. Block 808 is considered optional and is distinguished in FIG. 8 from the other blocks using a dashed outline. In Block 808, the compute resources of the witness node are reduced so as to not waste compute resources. In Block 810, a mirrored storage is created between the first and second computing sites and the witness node is moved into the mirrored storage. In one or more embodiments, the mirrored storage uses a network file system (NFS), a common internet file system (CIFS), or similar, file access storage protocol. In Block 812, an active node and a passive node in the plurality of nodes are determined based on the witness node. No pair of the active, passive, and witness nodes are the same node. That is, the active node and the passive node cannot be the same node. The active node and the witness node cannot be the same node. And the passive node and the witness node cannot be the same node. Further, the active node is said to be, at least initially, at the first computing site and the passive node is at the second computing site. In Block 814, a high-availability application is run on the active node and the active node is replicated to the passive node. In Block 816, it is determined whether a failure has occurred at the first computing site. The determination is based on one or more of the monitored compute and memory resources of the plurality of nodes (see Block 804) and an application performance, where the application performance indicates a degradation or stoppage of the high-availability application. In Block 818, the witness node is restarted at the second computing site in response to determining that the failure occurred at the first computing site. Further, the restart of the witness node at the second computing site designates the passive node as the active node and the high-availability application is run on the newly-designated active node. In one or more embodiments, a recovery operation is executed to restore the first computing site from the failure. In some scenarios, a determination (e.g., another determination) can be made that a failure occurs at the second computing site when the witness node and active node are implemented at the first computing site. In these scenarios, the witness node is maintained at the first computing site and a recovery operation is executed to restore the second computing site from the failure.

Embodiments of the instant disclosure allow a user or organization to run a high-availability application—and specifically, a high-availability application that conventionally requires three computing sites—using only two computing sites. Thus, there is a reduction of cost and resource requirements by eliminating the need for a third computing site, while still maintaining high availability of an application in the event of a failure.

In summary, embodiments disclosed herein relate to a system and method to utilize virtualization and mirrored network storage to allow simulated third site ability by hosting the witness node(s) in a storage that is always available between both sites of a two-site cluster. Specifically, having established the the witness node(s) in a first site of the two-site cluster including an active node (or otherwise known as the initially active site), the witness node(s) is restarted in the second site (initially having a passive node) in response to a determined failure at the first site. The witness node, once restarted at the second site, designates the second site as active such that an initially passive node at the second site become the active node and the initially active node at the first site becomes the passive node. Because one of the first and second sites are always expected to be operational (or at least to a reasonable degree, e.g., the probability of both sites experiencing simultaneous failures being less than, say, 0.001% with respect to operation time), an application run using the active node(s) has high availability. Thus, embodiments disclosed herein allow for so-called “three-site” applications to run using only two sites (i.e., a cluster with nodes distributed over only two computing sites).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A system providing a three-site configuration for a high-availability application with two computing sites, comprising:
a first computing site comprising a first node initially designated as an active node;
a second computing site physically displaced from the first computing site and comprising a second node initially designated as a passive node;
a network storage that is mirrored between, and available to, the first computing site and the second computing site; and
a witness node configured principally for voting which of the first and second nodes are the active and passive nodes, respectively, and hosted in the network storage,
wherein the witness node initially operates at the first computing site,
wherein the first computing site and the second computing site are configured as a stretched cluster.

2. The system of claim 1, further comprising a failure detection module configured to detect a failure of the first node and designate the second node as the active node and the first node as the passive node in response to the detected failure.

3. The system of claim 2, wherein:
in response to the detected failure of the first node, the witness node is restarted from the network storage at the second computing site, and
the second node is designated as the active node and the first node as the passive node in response to the restarting of the witness node at the second computing site.

4. The system of claim 1, wherein the witness node is configured to vote as the active node the first node or the second node according to the computing site in which the witness node operates.

5. The system of claim 1, wherein a third computing site is simulated by the hosting of the witness node in the network storage that is available to the first computing site and the second computing site.

6. The system of claim 1, further comprising a wide area network system that connects the first computing site and the second computing site.

7. The system of claim 1, wherein:
the system is configured to provide a virtualized environment comprising one or more virtual machines,
the system is further configured to restart a virtual machine of the one or more virtual machines in response to a detected failure.

8. The system of claim 1, wherein the network storage is unaffected by a non-concurrent failure of the first and second computing sites.

9. The system of claim 1, further comprising a witness node identification module that identifies the witness node within a plurality of nodes comprised by the system.

10. The system of claim 9, wherein the witness node identification module is configured to determine the witness node within the plurality of nodes based on a comparison of a compute and memory usage of the plurality of nodes.

11. A method, comprising:
provide a cluster including a plurality of nodes distributed over a first computing site and a second computing site configured as a two-site stretched cluster, wherein the cluster having network resources including network storage and configured with a virtualized environment;
monitoring a compute and memory resources of the plurality of nodes;
determining, from the plurality of nodes, a witness node that uses less compute and memory resources relative to the other nodes in the plurality of nodes;
creating a mirrored storage between the first and second computing sites and moving the witness node into the mirrored storage;
determine, based on the witness node, an active node and a passive node in the plurality of nodes, wherein no pair of the active, passive, and witness nodes are the same node, and wherein the active node is, at least initially, at the first computing site and the
passive node is at the second computing site; and
running a high-availability application on the active node and replicating the active node to the passive node.

12. The method of claim 11, further comprising reducing the compute resources of the witness node.

13. The method of claim 11, further comprising determining an application performance of the high-availability application.

14. The method of claim 13, further comprising determining, based on one or more of the monitored compute and memory resources of the plurality of nodes and the application performance, whether a failure has occurred at the first computing site.

15. The method of claim 14, further comprising restarting the witness node at the second computing site in response to determining that the failure occurred at the first computing site, wherein the restart designates the passive node as the active node and the high-availability application is run on the newly-designated active node.

16. The method of claim 15, further comprising executing a recovery operation to restore the first computing site from the failure.

17. The method of claim 11, wherein determining the witness node further comprises monitoring a storage utilization between nodes to identify the witness node as having a low storage utilization relative to the other nodes in the plurality of nodes.

18. The method of claim 11, wherein the mirrored storage uses a network file system (NFS) file access storage protocol.

19. The method of claim 11, further comprising determining, based on one or more of the monitored compute and memory resources of the plurality of nodes and an application performance, whether a failure has occurred at the second computing site.

20. The method of claim 19, further comprising:
maintaining the witness node at the first computing site in response to determining that the failure occurred at the second computing site; and
executing a recovery operation to restore the second computing site from the failure.
